(19) United States
(12) Patent Application Publication
(10) Pub. No.: US 2009/0108166 A1
(43) Pub. Date: Apr. 30, 2009

(54) Anchoring Apparatus For Connecting Device Holder

(76) Inventor: Eagle Fan, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/930,167

(22) Filed: Oct. 31, 2007

(51) Int. Cl. B60R 11/00

(52) U.S. Cl. 248/503; 248/346.2

(57) ABSTRACT

An anchoring apparatus for device holder is provided, including a base, a connection module and an engaging unit. The base is heavy in weight, including a frame, at least a stuffing, and a covering part. The covering part covers the stuffing and the frame, and has an anti-slippery cloth and an anti-slippery pad, which form the bottom surface of the base. The stuffing is made of heavy material in the form of grains or powder. The frame includes a coupling part located outside of the covering part. The connection module is located between the base and the engaging unit. The manner of connection between the connection module and the base, and between the connection module and the engaging unit is coupling to allow the angle adjustment between these components. The engaging unit includes a buckle part with design matching the engaging component of the device holder. The center of mass of the engaging unit and the connection module is within the area of the base so that the anchoring apparatus ahs a low center of mass and provides stable anchoring to the device holder.

### FIELD OF THE INVENTION

The present invention generally relates to an anchoring apparatus for connecting device holders used in cars, and more specifically to an anchoring apparatus with a low center of mass for connecting the device holders for holding electronic devices used in the cars, with a heavy weight and anti-slippery bottom surface to anchor the devices when placed in the cars.

### BACKGROUND OF THE INVENTION

The supporting rod for vehicles is a widely used auxiliary apparatus for cars used by the driver to hold small electronic devices when driving. The supporting rod is to provide supportive connection to a device holder so that the device holder can be adjusted for the convenient use of the small electronic devices, such as mobile phones, video player, PDA, GPS, digital TV, and so on. Some supporting rods are designed to be engage to a removable clapping holder, while others have the clapping holder fixed to the supporting rod. As not all the electronic devices are used by the drivers of the cars, the supporting rod is not a standard option to the cars. The supporting rod manufacturers usually design the supporting rods to be used with the wind shield, dash board, lighters, and so on.

Based on the manner that the supporting rod is engaged to the car, the conventional supporting rods care classified into three categories:
1. plugging into the lighter hole on the panel, the disadvantage is the possibility to damage the lighter;
2. gluing to the flat dash board, the disadvantage is the difficulty of glue removal in the future; and
3. using sucker for attaching to the windshield, its disadvantage is the blocking of the driver's view, thus this type of supporting rod is still prohibited in some countries.

### SUMMARY OF THE INVENTION

The primary object of the present invention is to provide an anchoring apparatus for device holders. The anchoring apparatus provides connection to device holder for holding small electronic devices, such as mobile phones, when driving. The anchoring apparatus does not use the glue or suction to attach when used, instead, the anchoring apparatus relies on the heavy weight and the anti-slippery bottom surface to stay on the flat dash board. This design avoids the blocking of the driver's view or damaging the interior design of the car caused by the conventional supporting rods.

Another object of the present invention is to provide an anchoring apparatus with low center of mass. The anchoring apparatus has a heavy weight base connected to a connection module and an engaging unit. The connection module and the engaging unit allow the angle adjustment while keeping the center of mass within the area of the base. When the device held by the device holder is engaged to the anchoring apparatus, the device will not tip over or move during driving.

Yet another object of the present invention is to provide an anchoring apparatus with an antenna unit for providing better reception quality to wireless communication devices, such as GPS, digital TV, and so on.

To achieve the aforementioned objects, the present invention provides an anchoring apparatus for device holder, including a base, a connection module and an engaging unit. The base is heavy in weight, including a frame, at least a stuffing, and a covering part. The covering part covers the stuffing and the frame, and has an anti-slippery cloth and an anti-slippery pad, which form the bottom surface of the base. The stuffing is made of heavy material in the form of grains or powder. The frame includes a coupling part located outside of the covering part. The connection module is located between the base and the engaging unit. The manner of connection between the connection module and the base, and between the connection module and the engaging unit is coupling to allow the angle adjustment between these components. The engaging unit includes a buckle part with design matching the engaging component of the device holder. The center of mass of the engaging unit and the connection module is within the area of the base so that the anchoring apparatus ahs a low center of mass and provides stable anchoring to the device holder.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a three-dimensional schematic view of the present invention;

FIG. 2 shows a bottom view of the structure shown in FIG. 1;

FIG. 3A shows aside view of the present invention depicting the adjustment of first connection element;

FIG. 3B shows aside view of the present invention depicting the adjustment of second connection element;

FIG. 3C shows aside view of the present invention depicting the adjustment of engaging part;

FIG. 4 shows a dissected view of the present invention;;

FIG. 5 shows a schematic view of the present invention applied to a device holder; and

FIG. 6 shows a three-dimensional schematic view of the second embodiment of the present invention.

### DETAILED DESCRIPTION OF THE PREFERRED EMBODIMENTS

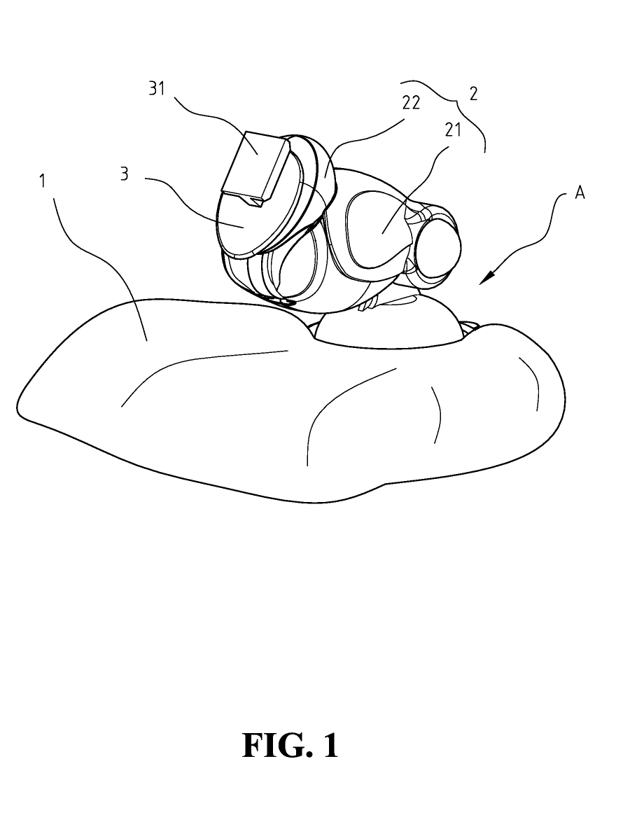

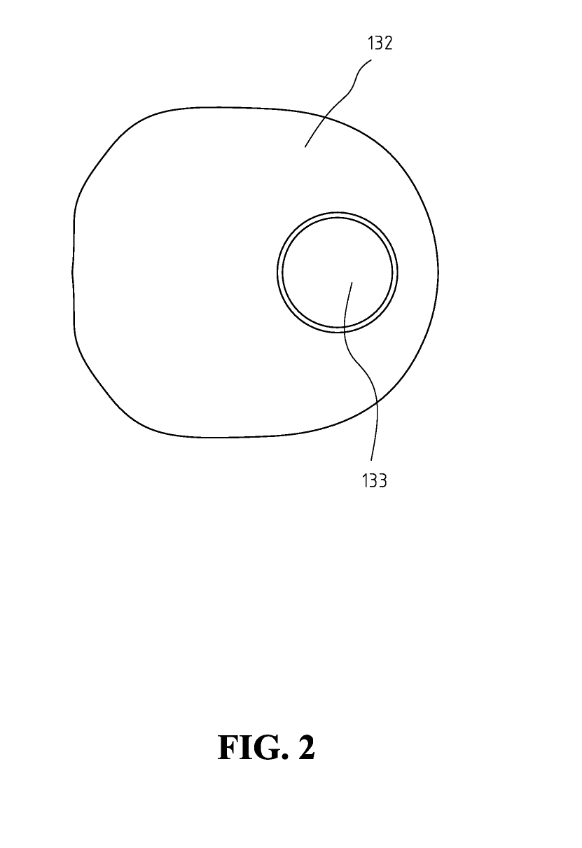

FIG. 1 shows a three-dimensional schematic view of the present invention. An anchoring apparatus A for device holder of the present invention includes a base 1, a connection module 2 and an engaging unit 3. Base 1 is sufficiently heavy in weight with a bottom surface having an anti-slippery cloth 132 and an anti-slippery pad 133, as shown in FIG. 2. Connection module is connected between base 1 and engaging unit 3, and the manner of connection is coupling so that engaging unit can be adjusted for different angles. Engaging unit 3 includes a buckle part 31 for engaging to other objects. In the present embodiment, the device holder can be engaged to engaging unit 3. The anchoring apparatus of the present invention has a low center of mass, and the center of mass of connection module 2 and engaging unit 3 is also within the area of base 1. When the electronic device is held by the device holder, and the device holder is engaged to engaging unit 3, anchoring apparatus A of the present invention can stays on the dash board stably during the drive.

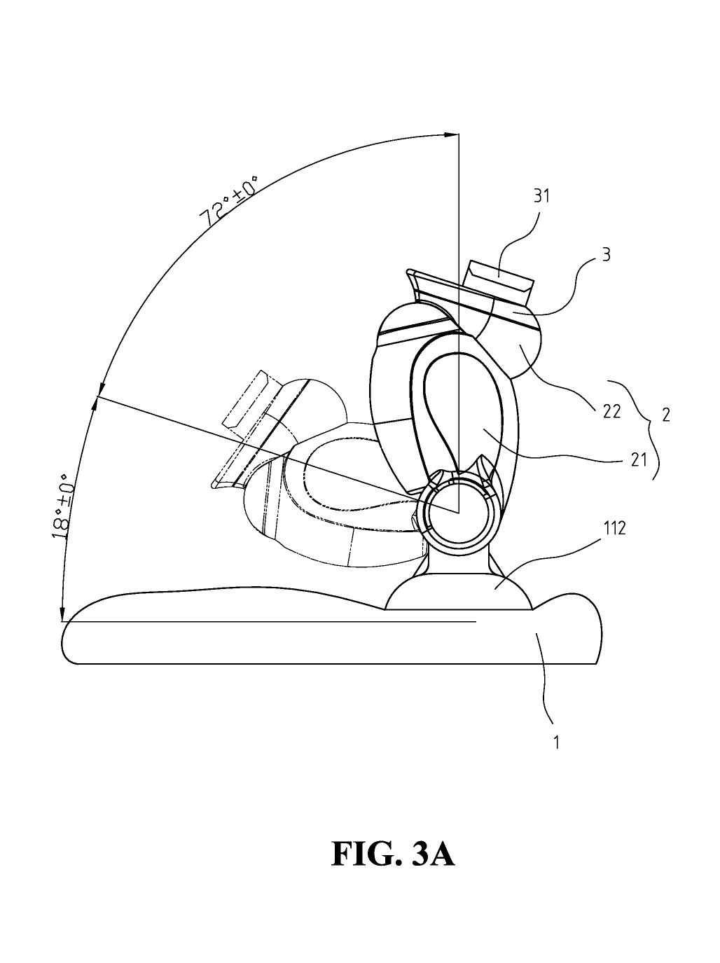

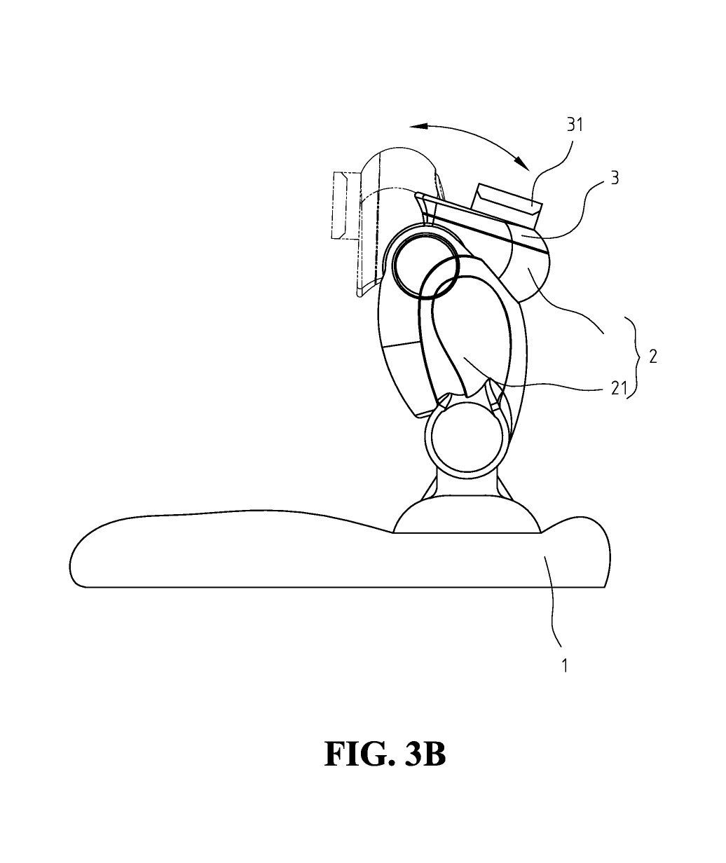

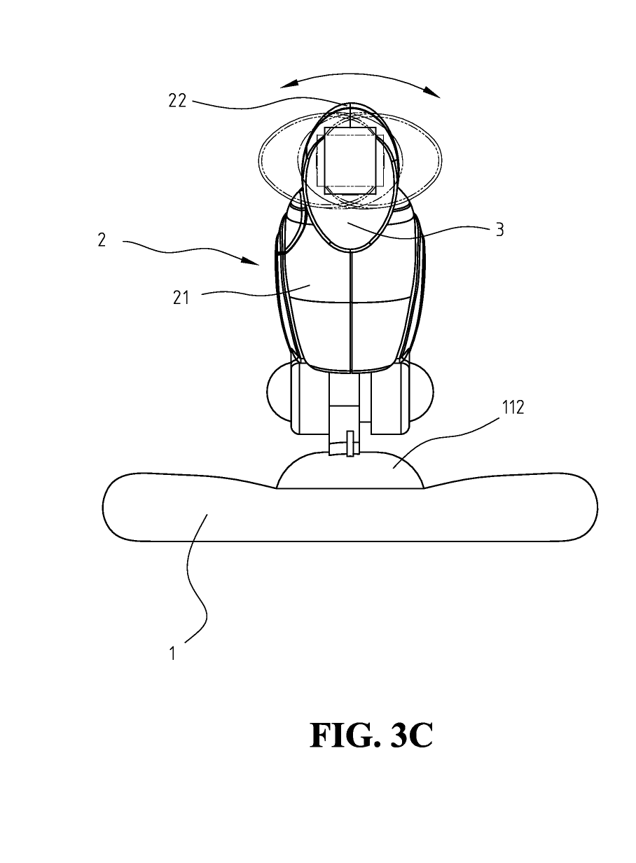

Connection module 2 is connected between base 1 and engaging unit 3. Connection module 2 can be a monolithic component with two ends coupled to base 1 and engaging unit 3 respectively. Connection module 2 can also include a plurality of connected elements to form a multi-sectional connection joint to allow more angle adjustment freedom of engaging unit 3 coupled to the end of connection module 2. The following description applies to a multi-sectional structure of connection module 2. As shown in FIGS. 3A and 3B, connection module 2 includes a first connection element 21 and a second connection element 22. The bottom of first connection element 21 is coupled to a coupling part 112 of base 1, and the top of first connection element 21 is coupled to second connection part 22. The other side of second connection element 22 is coupled to engaging unit 3. As shown in FIG. 3A, first connection element 21 allows wider angle adjustment within the 90° limit in the vertical direction so that the center of mass of first connection element 21 always stays within the area of base 1. As shown in FIG. 3B, second connection element 22 allows smaller angle adjustment in the vertical direction. As shown in FIG. 3C, engaging unit 3 can be adjusted in different direction from first connection element 21 and second connection element 22.

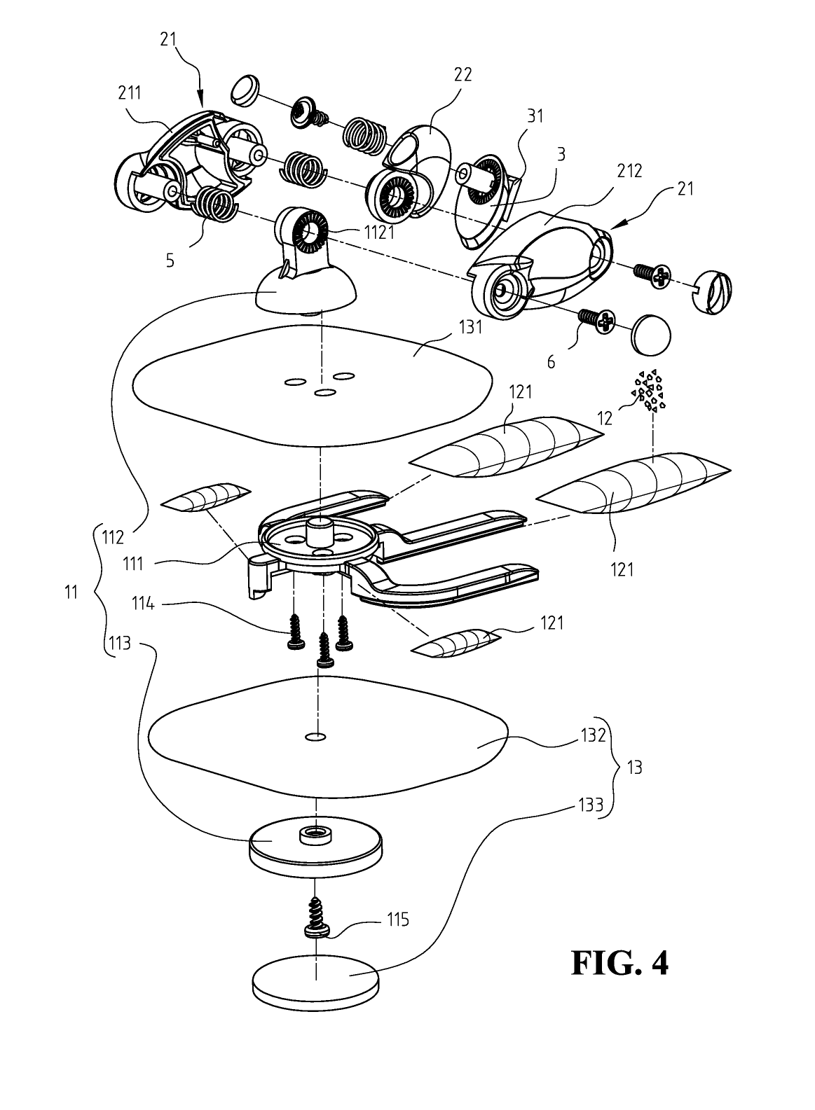

The following describes the components of the present invention in more details. FIG. 4 shows a dissected view of the present invention. As shown in FIG. 4, base 1 includes a frame 11, a stuffing 12 and a covering part 13. Frame 11 includes a backbone 111, a coupling part 112, an engaging plate 113, a plurality of screws 114 and a bolt 115. Backbone 111 is shaped as a fork, and coupling part 112 is placed on top of backbone 111. Plural screws 114 are for engaging back bone 111 and coupling part 112 together. Engaging plate 113 is placed below backbone 111, and bolt 115 is for engaging backbone 111 and engaging plate 113 together. Frame 11 uses coupling part 112 to couple with first connection element 21 of connection module 2. Covering part 13 is to cover the majority of frame 11 and stuffing 12. There are many ways to embody the covering part. The present embodiment shows a cover part 13 including a surface layer cloth 131, an anti-slippery cloth 132 and an anti-slippery pad 133. When assembled, the central area of surface layer cloth 131 is fixed to between frame 111 and coupling part 112, the central area of anti-slippery cloth 132 is fixed to between frame 111 and engaging plate 113, and anti-slippery pad 133 is glued to the bottom surface of engaging plate 113. Finally, the rims of surface layer cloth 131 and anti-slippery cloth 132 are sewed together. Anti-slippery pad 133 is made of soft, sticky and anti-slippery material. Stuffing 12 is made of sufficiently heavy material in the form of grains of powder. In the present embodiment, stuffing 12 can be sand, pebble, or iron block, or any combination of the above. To simply the assembly, stuffing 12 can be packaged into a plurality of bags 121. The weight and the size of bags 121 can be either identical or different. Before covering part 13 is sealed, the manufacturer can place a plurality of bags 121 inside covering part 13 before sewing up.

Connection module 2 includes a first connection element 21 and a second connection element 22. First connection element 21 is coupled with coupling part 112 of base 1, and second connection element 22 is coupled with engaging unit 3. Because the coupling manner between coupling part 112, first connection element 21, second connection element 22 and engaging unit 3 are similar, the following embodiment only describes the coupling structure between first connection element 21 and coupling part 112. The coupling structure further requires a spring 5 and a screw 6. In the present embodiment, first connection element 21 includes a left cap 211, and a right cap 212, the vertical surface on a side of the upper part of coupling part 112 includes a teeth part 1121, and the corresponding location on right cap 212 also includes teeth surface (not shown in FIG. 4). When assembled, the upper part of coupling part 112 is located between left cap 211 and right cap 212 of first connection element 21. Spring 5 is stuck between left cap 211 and the upper part of coupling part 112. Screw 6 penetrates right cap 212 and the upper part of coupling part 112 to lock in left cap 211 as well as fix the relative positions of the coupling structure. Therefore, first connection element 21 can be adjusted to change the angle between coupling part 121 and first connection element 21. After the adjustment, teeth surface 1121 can prevent the un-intended rotation between first connection element 21 and coupling element 112.

Engaging unit 3 provides engagement to a device holder. Engaging unit 3 includes a buckle part 31. The shape of buckle part 31 is designed to match the component to be engaged. In the present embodiment, buckle part 31 is a T-shaped protruding block. However, the present invention is not limited to the above embodiment.

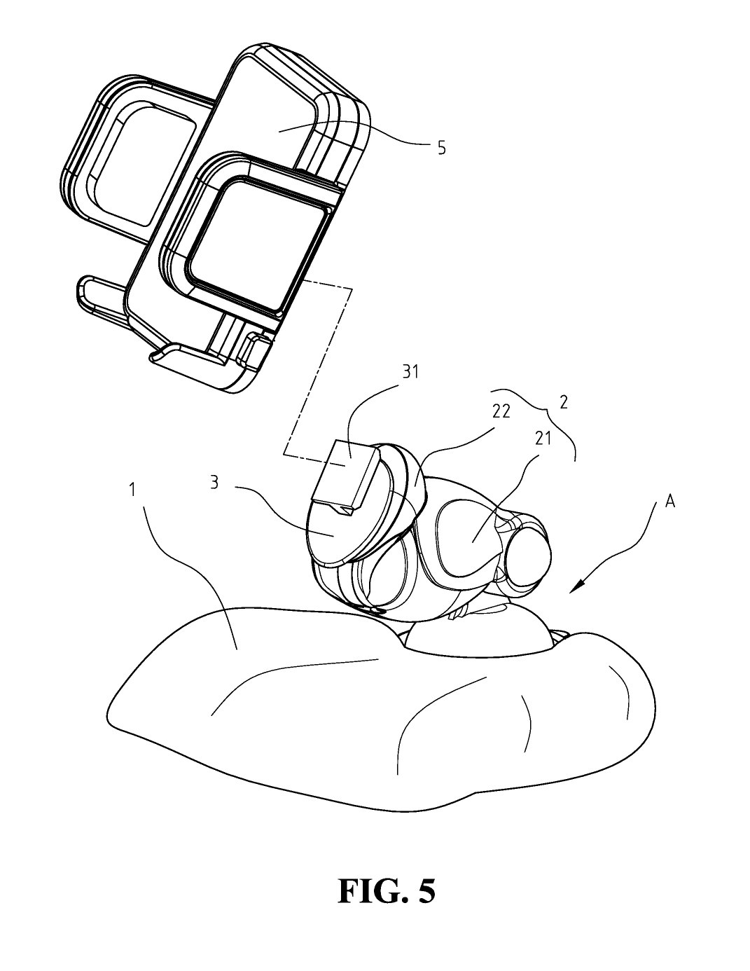

FIG. 5 shows a schematic view of the application of the present invention. Anchoring apparatus A provides engagement to a device holder 7. Device holder 7 uses the structure on the back surface to engage buckle part 31 of engaging unit 3. In actual application, anchoring apparatus A is placed on the flat part of the dash board. With the weight of base 1, the anti-slippery cloth and the anti-slippery pad, base 1 of the present invention will not move on the flat dash board during drive. In addition, the center of mass of connection module 2 and engaging unit 3 stays also within the area of base 1; therefore, the anchoring apparatus of the present invention will not tip over. Hence, anchoring apparatus A of the present invention allows the driver to use the electronic devices without worrying the holding and fixing of the devices.

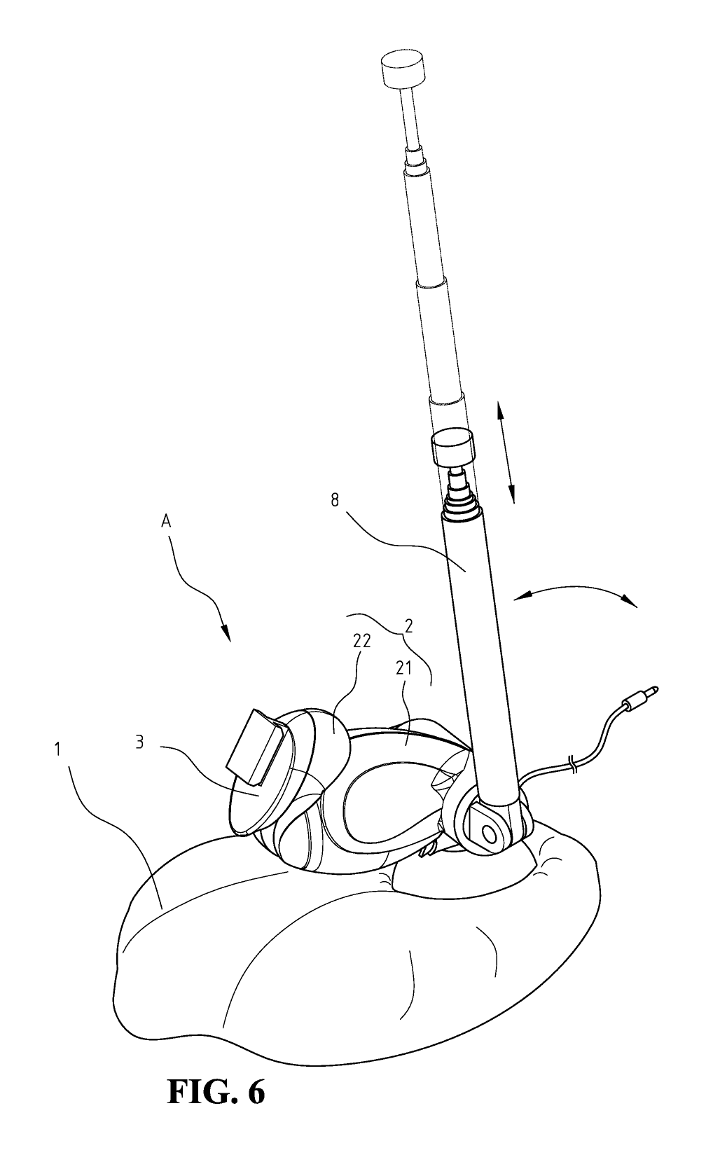

FIG. 6 shows the second embodiment of the present invention. In this embodiment, an antenna unit 8 is included. Antenna unit 8 can be a retractable antenna that allows angle adjustment. Antenna unit 8 is engaged to first connection part element 21 of connection module 2. With antenna unit 8, anchoring apparatus A provides better reception quality when used with wireless communication devices.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An anchoring apparatus for device holder, comprising a base, a connection module, and an engaging unit; wherein:
said base having a sufficient weight, further comprising a frame, at least a stuffing and a covering part, said stuffing having sufficient weight, said covering part covering said stuffing and the majority of said frame, said frame further comprising a coupling part, said coupling part located outside of said covering part, said covering part having an anti-slippery cloth and an anti-slippery pad, the bottom surface of said base comprising said anti-slippery cloth and said anti-slippery pad;
the bottom of said connection module being coupled with said coupling part of said base and the top of said connection module being coupled with said engaging unit for allowing adjustment of the angles between said connection module, said base and said engaging unit; and
said engaging unit being coupled with said connection module, said engaging unit further comprising a buckle unit, the shape of said buckle unit being designed to match the shape of the component to be engaged to.

2. The anchoring apparatus as claimed in claim 1, wherein said connection module further comprises a first connection element and a second connection element, said first connection element has the bottom coupled with said coupling part of said base and the top coupled with said second connection element, and said second connection element has the other side coupled with said engaging unit.

3. The anchoring apparatus as claimed in claim 1, wherein said stuffing is made of sufficiently heavy material in the form of grains or powder, and said material can be sand, pebble, iron blocks, or any combination of the above.

4. The anchoring apparatus as claimed in claim 1, wherein said buckle part of said engaging unit provides engagement to a device holder.

5. The anchoring apparatus as claimed in claim 1, wherein the center of mass of said connection module and said engaging unit falls within the area of said base.

6. The anchoring apparatus as claimed in claim 1, wherein said connection module is engaged to an antenna unit.

7. The anchoring apparatus as claimed in claim 6, wherein said antenna unit is a retractable antenna.
